(19) United States
(12) Patent Application Publication
(10) Pub. No.: US 2004/0011883 A1
(43) Pub. Date: Jan. 22, 2004

(54) Liquid injection apparatus

(75) Inventors: Takao Ohnishi, Nishibiwajima-Cho (JP); Toshikazu Hirota, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/621,077

(22) Filed: Jul. 16, 2003

(30) Foreign Application Priority Data
Jul. 18, 2002 (JP) 2002-209178

(51) Int. Cl. B05B 1/08

(52) U.S. Cl. 239/102.2; 239/102.1; 239/533.1

(57) ABSTRACT

A liquid injection apparatus includes an injection unit attached to a liquid injection space which is formed by, for example, an intake pipe of an internal combustion engine, and a pressure pump for pressurizing liquid fed from a liquid storage tank to a pressure enabling injection, and for feeding the liquid to the injection unit. In order to atomize the liquid fed from the pressure pump, the injection unit includes a plurality of chambers, each of which has a piezoelectric/electrostrictive element fixed to its wall surface, and a plurality of liquid discharge nozzles. A force which is induced by liquid pressure in the chambers and imposed on the piezoelectric/electrostrictive elements via the walls of the chambers is almost completely canceled by a counterforce induced by liquid pressure in counterforce source chambers. The liquid pressure in the counterforce source chambers is substantially equal to that in the chambers.

### BACKGROUND OF THE INVENTION

1. Field of the Invention

The present invention relates to a liquid injection apparatus applied to various machinery which utilizes liquid material, liquid fuel, or the like injected into a liquid injection space, and adapted to inject liquid in an atomized form into the liquid injection space.

2. Description of the Related Art

Conventionally known liquid fuel injection apparatus include a fuel injection apparatus for use in an internal combustion engine. The fuel injection apparatus for use in an internal combustion engine is a so-called electrically controlled fuel injection apparatus, which is in wide use and includes a pressure pump for pressurizing liquid, and a solenoid-operated injection valve. In the electrically controlled fuel injection apparatus, fuel which is pressurized by means of the pressure pump is injected from an injection port of the solenoid-operated injection valve. As a result, liquid droplets of injected fuel generally have a relatively large size of at least about 100 μm and are not of uniform size. Such a size of liquid droplets of fuel and nonuniformity of liquid droplets of fuel increase the amount of unburnt fuel during combustion, leading to increased emission of harmful exhaust gas.

Meanwhile, Japanese Patent Application Laid-Open (kokai) No. S54-90416 discloses a liquid droplet ejection apparatus. In the liquid droplet ejection apparatus, a portion of a wall which partially constitutes a liquid feed path is deformed through operation of a piezoelectric electrostriction element (a piezoelectric/electrostrictive element) so as to pressurize liquid contained in the liquid feed path, thereby ejecting the liquid from an outlet in the form of fine liquid droplets. Such an apparatus utilizes the principle of an ink jet ejection apparatus disclosed in, for example, Japanese Patent Application Laid-Open (kokai) No. H06-40030 and can eject finer liquid droplets (liquid droplets of injected fuel) of uniform size as compared with the above-mentioned electrically controlled fuel injection apparatus, thereby exhibiting excellent fuel atomization performance.

Meanwhile, an ink jet ejection apparatus can inject fine liquid droplets as expected when used in a relatively steady atmosphere with little variation in temperature, pressure, and the like (e.g., in an office, a classroom, or a like indoor space). However, the ink jet ejection apparatus usually fails to exhibit sufficient fuel atomization performance when used under wildly fluctuating atmospheric conditions as found in an internal combustion engine, which involves fluctuating operating conditions. Under the present circumstances, there has not been provided a liquid (fuel) injection apparatus which utilizes the principle of an ink jet ejection apparatus and can inject sufficiently atomized liquid even when used in a mechanical apparatus involving wildly fluctuating atmospheric conditions as in the case of an internal combustion engine.

As in the case of the above-mentioned liquid droplet ejection apparatus, when a portion of a wall which partially constitutes a liquid feed path is deformed through operation of a piezoelectric electrostriction element, the piezoelectric electrostriction element causes deformation of the wall of the liquid feed path against a force induced by liquid pressure in the liquid feed path. Thus, the magnitude of a force required to operate the piezoelectric electrostriction element (power consumption of the electrostriction element) increases in response to an increase of maximum liquid pressure in the liquid feed path (maximum ejection pressure for fine liquid droplets to be ejected from an outlet). Therefore, when the above-mentioned apparatus is used in an environment in which ejected fine liquid droplets must have a high maximum ejection pressure (e.g., when the pressure of a liquid injection space into which liquid is to be injected is high), the following problem arises: the increased maximum ejection pressure increases power consumption of the apparatus and requires use of a piezoelectric electrostriction element of high output, or liquid pressure for liquid to be injected fails to be sufficiently fluctuated, leading to impairment in the performance for atomizing the liquid.

### SUMMARY OF THE INVENTION

An object of the present invention is to provide a liquid injection apparatus capable of injecting liquid in the form of droplets of small and uniform size in a stable atomization condition. Another object of the present invention is to provide a liquid injection apparatus configured in such a manner as to be able to stably inject liquid even when used under wildly and abruptly fluctuating environmental conditions observed in a liquid injection space or the like. A further object of the present invention is to provide a liquid injection apparatus configured in such a manner as to be able to suppress an increase in power consumption even when used in an environment which requires injection of liquid under high pressure.

To achieve the above objects, the present invention provides a liquid injection apparatus comprising: an injection unit comprising a flow path formation portion, the flow path formation portion including a liquid discharge nozzle, one end of the liquid discharge nozzle being exposed to a liquid injection space, and a chamber communicating with the other end of the liquid discharge nozzle and with one end of a liquid feed pipe; a drive voltage generation device for generating a drive voltage signal having a predetermined frequency; and a pressurizing device comprising a discharge portion connected to the other end of the liquid feed pipe and an introduction portion communicating with a liquid storage tank. The pressurizing device is adapted to pressurize liquid introduced from the liquid storage tank through the introduction portion and to discharge the liquid under pressure from the discharge portion, so as to inject the liquid into the liquid injection space via the chamber and the liquid discharge nozzle of the injection unit. The injection unit further comprises a pressurizing portion. The pressurizing portion includes a piezoelectric/electrostrictive element and a counterforce application mechanism. The piezoelectric/electrostrictive element has a fixation surface fixed to an outer surface of a wall of the chamber and receiving, via the wall, a force induced by liquid pressure in the chamber and expands and contracts mainly in a direction along the fixation surface so as to deform the wall of the chamber for changing a volume of the chamber. The counterforce application mechanism applies to a nonfixation surface of the piezoelectric/electrostrictive element a counterforce directed toward the fixation surface. The drive voltage signal issued from the drive voltage generation device causes the piezoelectric/electrostrictive element to expand and contract so as to atomize liquid injected from the liquid discharge nozzle. Notably, the term “communicate” means direct or indirect connection. Herein, the term “pipe” is used as a synonym of the term “path.”

According to this apparatus, expansion and contraction (operation) of the piezoelectric/electrostrictive element causes the volume of the chamber to fluctuate, thereby applying vibration energy (may be called merely as “vibration”) to liquid to be injected. Thus, the liquid is injected from the liquid discharge nozzle in the form of liquid droplets formed through atomization.

In this case, the size of liquid droplets of liquid formed through atomization depends on pressure applied to liquid, the amplitude and frequency of vibration of the piezoelectric/electrostrictive element, the shape of a flow path, dimensions of the flow path, physical properties such as viscosity and surface tension of liquid, and other factors. However, when the period of vibration imposed on liquid is shorter than the time required for liquid to move along a length equivalent to the diameter of an end portion (an opening exposed to the liquid injection space) of the liquid discharge nozzle in the vicinity of the end portion, the size of a liquid droplet of injected liquid becomes substantially equal to or less than the diameter of the end portion of the liquid discharge nozzle. Therefore, for example, through employment of a diameter not greater than several tens of micrometers for the end portion (opening) of the liquid discharge nozzle exposed to the liquid injection space, the above-mentioned liquid injection apparatus can inject liquid droplets in a uniformly and finely atomized condition. For example, when the liquid injection apparatus is used as a fuel injection apparatus for an internal combustion engine, the liquid injection apparatus can atomize injected fuel into liquid droplets of an appropriate diameter, thereby enhancing fuel economy of the internal combustion engine and reducing harmful exhaust gas.

Also, according to the above-described configuration, pressure required to inject liquid is generated by the pressurizing device. Thus, even when atmospheric conditions (e.g., pressure and temperature) within the liquid injection space fluctuate wildly due to fluctuations in, for example, operating conditions of a machine to which the apparatus is applied, the liquid can be injected and fed stably in the form of expected fine droplets.

In a conventional carburetor, the flow rate of fuel (liquid) is determined according to air velocity within an intake pipe, which is a liquid droplet discharge space (liquid injection space), and the degree of atomization varies depending on the air velocity. By contrast, the above-described liquid injection apparatus of the present invention can eject fuel (liquid) by a required amount in a well-atomized condition irrespective of air velocity. Additionally, in contrast to a conventional apparatus in which assist air is fed to a nozzle portion of a fuel injector so as to accelerate fuel atomization, the liquid injection apparatus of the present invention does not require a compressor for feeding assist air, thereby lowering costs.

Furthermore, according to the above-described configuration, the deformation direction of the chamber wall is directed toward the fixation surface of the piezoelectric/electrostrictive element (for example, when the fixation surface is a plane, the direction is substantially perpendicular to the fixation surface), and a counterforce which is applied to the nonfixation surface of the piezoelectric/electrostrictive element by means of the counterforce application mechanism is a force directed toward the fixation surface of the piezoelectric/electrostrictive element. Thus, at least a component directed in the deformation direction of the chamber wall is present in the counterforce. Therefore, a component (or a portion of the component) of a force induced by liquid pressure in the chamber, the component being directed in the deformation direction of the chamber wall and imposed on the fixation surface of the piezoelectric/electrostrictive element via the chamber wall (through deformation of the chamber wall), is canceled by a component of the counterforce, the component being directed in the deformation direction of the chamber wall.

Therefore, when the piezoelectric/electrostrictive element is to deform the chamber wall by a predetermined amount against liquid pressure in the chamber, the magnitude of a force required to expand and contract (to perform contraction of) the piezoelectric/electrostrictive element is reduced by a degree corresponding to the above-mentioned canceled force. As a result, the voltage of the drive voltage signal to be applied to the piezoelectric/electrostrictive element can be lowered; thus, power consumption of the piezoelectric/electrostrictive element is reduced, and power consumption of the liquid injection apparatus is reduced as well. Therefore, even when the liquid injection apparatus is used in an environment which requires injection of liquid under high pressure (an environment in which the liquid pressure in the chamber must be high), an increase in power consumption of the liquid injection apparatus can be suppressed.

In this case, preferably, the counterforce application mechanism is configured in such a manner as to adjust the magnitude of the counterforce such that the magnitude of a component of the counterforce, the component being directed in the deformation direction of the chamber wall, becomes substantially equal to the magnitude of a component of the force induced by liquid pressure in the chamber, the component being directed in the deformation direction of the chamber wall and imposed on the fixation surface.

According to this configuration, a component of a force induced by liquid pressure in the chamber, the component being directed in the deformation direction of the chamber wall and imposed on the fixation surface of the piezoelectric/electrostrictive element via the chamber wall, is almost completely canceled by a component of the counterforce, the component being directed in the deformation direction of the chamber wall. As a result, the magnitude of a force required to expand and contract (to perform contraction of) the piezoelectric/electrostrictive element to thereby deform the wall of the chamber by a predetermined amount can be stably reduced, irrespective of liquid pressure in the chamber, to the magnitude of a force required when liquid pressure in the chamber is very low. Therefore, even when the liquid injection apparatus is used in an environment which requires injection of liquid under considerably high pressure, the liquid can be injected stably, and power consumption of the liquid injection apparatus can be reduced.

In the above-described liquid injection apparatus, preferably, the counterforce application mechanism comprises a counterforce source chamber into which liquid discharged from the discharge portion of the pressurizing device is introduced, and is configured such that a force induced by liquid pressure in the counterforce source chamber is applied, as the counterforce, to the nonfixation surface of the piezoelectric/electrostrictive element.

Through employment of the above configuration, the pressure of liquid discharged from the discharge portion of the pressurizing device, which is required for injection of the liquid, can be used as a counterforce. Thus, there is no need for the liquid injection apparatus to additionally employ a counterforce generation device or a like device dedicated to application of the counterforce to the nonfixation surface of the piezoelectric/electrostrictive element. Therefore, the liquid injection apparatus can be simply configured and can be rendered inexpensive.

Liquid discharged from the discharge portion of the pressurizing device is introduced directly or indirectly (e.g., via a regulator or the like) into the chamber and the counterforce source chamber. Thus, since liquid pressure in the chamber and liquid pressure in the counterforce source chamber can be easily rendered substantially equal to each other, the magnitude of a component of a counterforce, the component being directed in the deformation direction of the chamber wall, can be easily adjusted to be substantially equal to the magnitude of a component of a force induced by liquid pressure in the chamber, the component being directed in the deformation direction of the wall. As a result, as in the case mentioned above, even when the liquid injection apparatus is to be used in an environment which requires injection of liquid under considerably high pressure, the liquid injection apparatus can inject the liquid through employment of a simple configuration, and power consumption of the liquid injection apparatus can be reduced.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a schematic diagram showing a liquid injection apparatus according to an embodiment of the present invention;

FIG. 2 is a plan view of an injection unit of the liquid injection apparatus shown in FIG. 1;

FIG. 3 is a sectional view of the injection unit cut by a plane extending along line III-III of FIG. 2;

FIG. 4 is a sectional view of the injection unit cut by a plane extending along line IV-IV of FIG. 3;

FIG. 5 is a time chart showing time-course relationship among drive signals and a drive voltage signal; and

FIG. 6 is a view showing the condition of liquid injected from the liquid injection apparatus shown in FIG. 1.

### DESCRIPTION OF THE PREFERRED EMBODIMENT

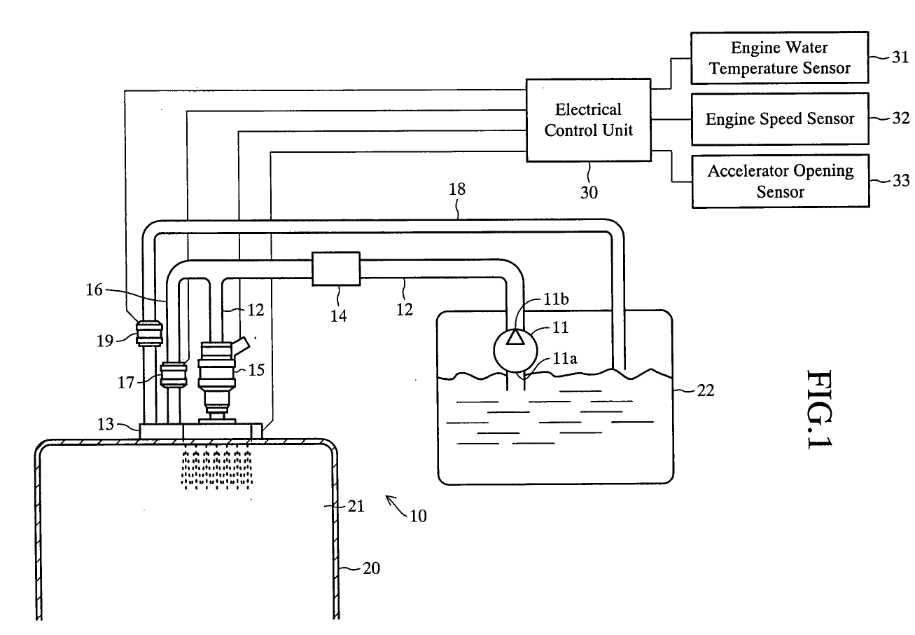

An embodiment of the present invention will be described in detail. A liquid injection apparatus (liquid atomization apparatus, liquid feed apparatus, or liquid droplet discharge apparatus) 10 according to the embodiment of the present invention, its configuration being schematically shown in FIG. 1, is adapted to inject atomized liquid (liquid fuel; e.g., gasoline; hereinafter may be called merely as “fuel”) into, for example, a fuel injection space 21 defined by an intake pipe 20 of an internal combustion engine. The liquid injection apparatus 10 includes a pressure pump 11, which serves as a pressurizing device; a liquid feed pipe 12; an injection unit (atomization unit) 13, which communicates with one end of the liquid feed pipe 12 and includes a plurality of liquid discharge nozzles and a plurality of chambers having respective piezoelectric/electrostrictive elements formed at least on their walls in order to atomize fuel to be injected; a regulator 14 installed in the liquid feed pipe 12; a fuel injector 15 installed in the liquid feed pipe 12 and located between the regulator 14 and the injection unit 13; a counterforce medium feed pipe 16 branching off from the liquid feed pipe 12 at a position located between the regulator 14 and the fuel injector 15 and communicating with the injection unit 13; a solenoid-operated counterforce medium feed on-off valve 17 installed in the counterforce medium feed pipe 16; a counterforce medium release pipe 18 communicating with the injection unit 13 and with a liquid storage tank 22; a solenoid-operated counterforce medium release on-off valve 19 installed in the counterforce medium release pipe 18; and an electrical control unit 30.

The pressure pump 11 communicates with the liquid storage tank 22 and includes an introduction portion 11a, through which fuel is fed from the liquid storage tank 22, and a discharge portion 11b connected to the other end of the liquid feed pipe 12. The pressure pump 11 pressurizes the fuel which is received from the liquid storage tank 22 through the introduction portion 11a, to a pressure which enables injection of the fuel into the fuel injection space 21 via the regulator 14, the fuel injector 15, and the injection unit 13 (even when the piezoelectric/electrostrictive elements of the injection unit 13 are inactive); and discharges the pressurized fuel into the liquid feed pipe 12 from the discharge portion 11b.

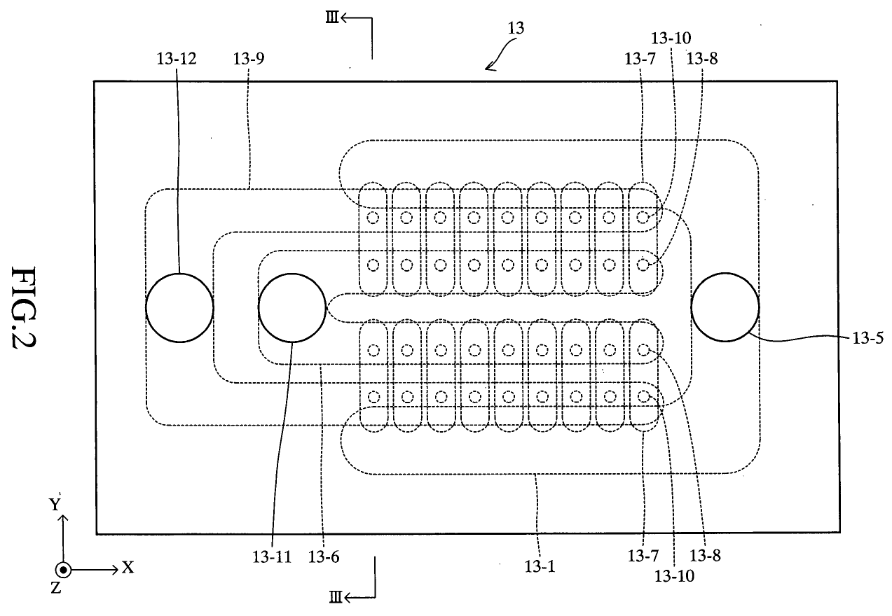

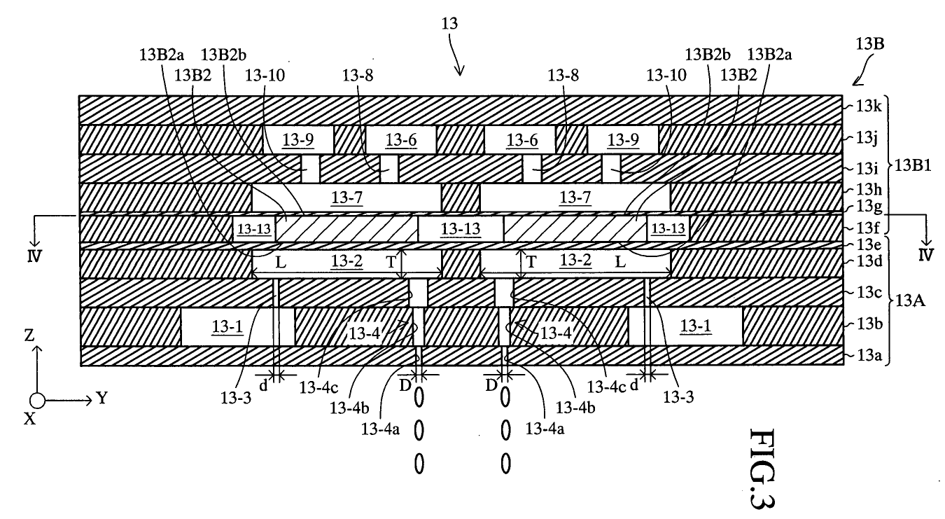

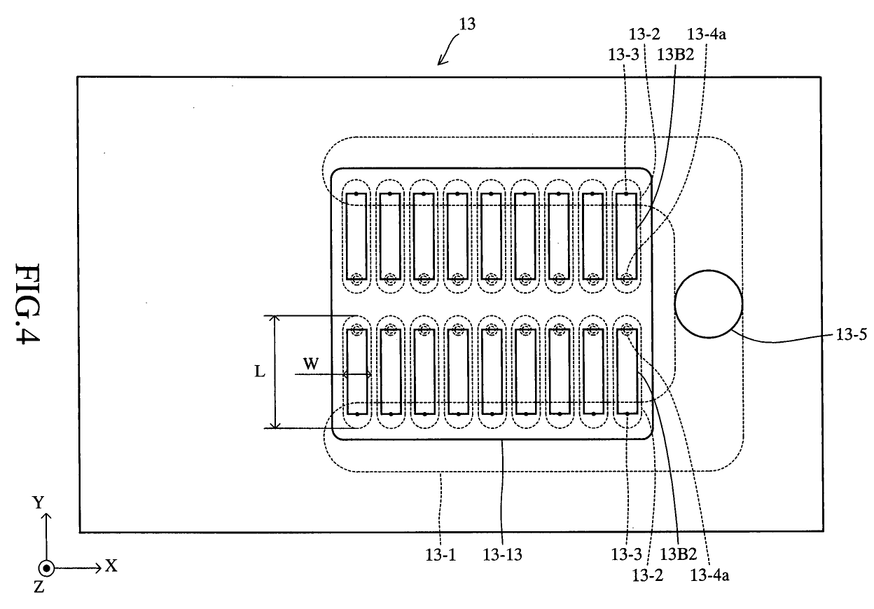

As shown in FIG. 2, which is a plan view showing the injection unit 13, FIG. 3, which is a sectional view of the injection unit 13 cut by a plane extending along line III-III of FIG. 2, and FIG. 4, which is a sectional view of the injection unit 13 cut by a plane extending along line IV-IV of FIG. 3, the injection unit 13 assumes the shape of a rectangular parallelepiped whose sides extend in parallel with mutually orthogonal X-, Y-, and Z-axes, and includes a flow path formation portion 13A and a pressurizing portion 13B. The flow path formation portion 13A is formed by a plurality of zirconia ceramic thin-plate members (hereinafter called “ceramic sheets”) 13a to 13e, which are sequentially arranged in layers and joined under pressure. The pressurizing portion 13B includes a counterforce application mechanism portion 13B1 (counterforce application mechanism) and a plurality of (herein nine per row, 18 in total) piezoelectric/electrostrictive elements 13B2. The counterforce application mechanism portion 13B1 is formed by a plurality of stainless steel (SUS304) thin-plate members (hereinafter called “stainless sheets”) 13f to 13k, which are sequentially arranged in layers and joined under pressure on the upper surface (a plane extending along the X-Y plane and located toward the positive side along the Z-axis) of the flow path formation portion 13A. The plurality of piezoelectric/electrostrictive elements 13B2 are fixed to the upper surface (a plane extending along the X-Y plane and located toward the positive side along the Z-axis) of the ceramic sheet 13e.

The flow path formation portion 13A includes internally a liquid feed path 13-1; a plurality of (herein nine per row, 18 in total) mutually independent chambers 13-2; a plurality of liquid introduction holes 13-3 for establishing communication between the chambers 13-2 and the liquid feed path 13-1; a plurality of liquid discharge nozzles 13-4, one end of each of the liquid discharge nozzles 13-4 being exposed to the liquid injection space 21 so as to establish communication between the chambers 13-2 and the exterior of the injection unit 13; and a liquid inlet 13-5 (a lower portion of the same), to which one end of the liquid feed pipe 12 is connected.

The counterforce application mechanism portion 13B1 of the pressurizing portion 13B includes internally the liquid inlet 13-5 (an upper portion of the same); a counterforce medium feed path 13-6; a plurality of (herein nine per row, 18 in total) mutually independent counterforce source chambers 13-7; a plurality of counterforce medium introduction holes 13-8 which establish communication between the counterforce source chambers 13-7 and the counterforce medium feed path 13-6; a counterforce medium release path 13-9; a plurality of counterforce medium release holes 13-10 which establish communication between the counterforce source chambers 13-7 and the counterforce medium release path 13-9; a counterforce medium feed port 13-11 to which the counterforce medium feed pipe 16 is connected; a counterforce medium release port 13-12 to which the counterforce medium release pipe 18 is connected; and a piezoelectric/electrostrictive element accommodation chamber 13-13.

The liquid feed path 13-1 is a space defined by the side wall surface of a substantially U-shaped cutout formed in the ceramic sheet 13b, the upper surface of the ceramic sheet 13a, and the lower surface of the ceramic sheet 13c. The substantially U-shaped cutout is formed in such a manner as to extend, along the X-Y plane, in the positive direction of the Y-axis and in the negative direction of the Y-axis from a portion communicating with the bottom end (an end located in the negative direction of the Z-axis) of the liquid inlet 13-5, which is a space defined by the side wall of a cylindrical through-hole extending in the direction of the Z-axis, and to then extend in the negative direction of the X-axis. The liquid feed path 13-1 communicates with the liquid storage tank 22 via the liquid inlet 13-5, the liquid feed pipe 12, in which the fuel injector 15 is installed, and the pressure pump 11. When the fuel injector 15 is opened, fuel to be injected (atomized) is fed under pressure to the liquid feed path 13-1 by means of the pressure pump 11.

Each of the chambers 13-2 is an elongated space defined by the side wall surface of an oblong cutout formed in the ceramic sheet 13d and having major and minor axes extending along the direction of the Y-axis and the direction of the X-axis, respectively, the upper surface of the ceramic sheet 13c, and the lower surface of the ceramic sheet 13e. One end portion of each of the chambers 13-2 extends to a position located above the liquid feed path 13-1, whereby each of the chambers 13-2 communicates, at the position corresponding to the one end portion, with the liquid feed path 13-1 via the cylindrical liquid introduction hole 13-3 having diameter d and formed in the ceramic sheet 13c. Hereinafter, the diameter d may be called merely as “introduction hole diameter d.” The other end portion of each of the chambers 13-2 is connected to the other end of the corresponding liquid discharge nozzle 13-4. The above configuration allows fuel to flow in the chambers 13-2 from the side toward the liquid feed pipe 12 to the side toward the liquid discharge nozzles 13-4.

Each of the liquid discharge nozzles 13-4 includes a cylindrical through-hole which is formed in the ceramic sheet 13a and has diameter D and whose one end (a liquid injection port, an opening or an opening portion exposed to the liquid injection space, or a discharge hole) 13-4a is exposed to the liquid injection space 21; and cylindrical communication holes 13-4b and 13-4c, which are formed in the ceramic sheets 13b and 13c, respectively, such that their size (diameter) increases stepwise toward the corresponding chamber 13-2 from the liquid injection port 13-4a. The axes of the liquid discharge nozzles 13-4 are in parallel with the Z-axis. Hereinafter, the diameter D may be called merely as “nozzle diameter D.”

The shape and size of the chambers 13-2 will be additionally described. Each of the chambers 13-2 assumes a substantially rectangular cross section as cut at its longitudinally (along the direction of the Y-axis) central portion (flow path portion) by a plane (X-Z plane) perpendicular to the direction of liquid flow. Major axis L (length along the Y-axis) and minor axis W (length along the X-axis) of the elongated flow path portion are 3.5 mm and 0.35 mm, respectively. Height T (length along the Z-axis) of the flow path portion is 0.15 mm. In other words, in the rectangular cross-sectional shape of the flow path portion, the ratio (T/W) of the length (height T) of a side perpendicular to a side (minor axis W) on which the piezoelectric/electrostrictive element is provided, to the length of the side (minor axis W) is 0.15/0.35=0.43. Preferably, the ratio (T/W) is greater than zero (0) and smaller than one (1).

The diameter D of the liquid discharge nozzle end portion 13-4a and the diameter d of the liquid introduction hole 13-3 are 0.031 mm and 0.025 mm, respectively. In this case, preferably, cross-sectional area S1 (=W×T) of the flow path of the chamber 13-2 is greater than cross-sectional area S2 (=π·(D/2)²) of the liquid discharge nozzle end portion 13-4a and greater than cross-sectional area S3 (=π·(d/2)²) of the liquid introduction hole 13-3. Also, preferably, for atomization of liquid, the cross-sectional area S2 is greater than the cross-sectional area S3.

The counterforce medium feed path 13-6 is a space defined by the side wall surface of a substantially U-shaped cutout formed in the stainless sheet 13j, the upper surface of the stainless sheet 13i, and the lower surface of the stainless sheet 13k. The substantially U-shaped cutout is formed in such a manner as to extend, along the X-Y plane, in the positive direction of the Y-axis and in the negative direction of the Y-axis from a portion communicating with the bottom end (an end located in the negative direction of the Z-axis) of the counterforce medium feed port 13-11, which is a space defined by the side wall of a cylindrical through-hole extending in the direction of the Z-axis, and to then extend in the positive direction of the X-axis. The counterforce medium feed path 13-6 communicates with the liquid storage tank 22 via the counterforce medium feed port 13-11, the counterforce medium feed pipe 16, in which the solenoid-operated counterforce medium feed on-off valve 17 is installed, the liquid feed pipe 12, and the pressure pump 11. When the solenoid-operated counterforce medium feed on-off valve 17 is opened, fuel (having the same pressure as that of fuel to be injected (atomized)) discharged under pressure from the discharge portion 11b of the pressure pump 11 is fed to the counterforce medium feed path 13-6.

Each of the counterforce source chambers 13-7 is an elongated space defined by the side wall surface of an oblong cutout formed in the stainless sheet 13h and having major and minor axes extending along the direction of the Y-axis and the direction of the X-axis, respectively, the upper surface of the stainless sheet 13g, and the lower surface of the stainless sheet 13i. A portion of each of the counterforce source chambers 13-7 is located below the counterforce medium feed path 13-6, whereby each of the counterforce source chambers 13-7 communicates, at the position corresponding to the portion, with the counterforce medium feed path 13-6 via the cylindrical counterforce medium introduction hole 13-8 formed in the stainless sheet 13i. Therefore, as in the case of the counterforce medium feed path 13-6, when the solenoid-operated counterforce medium feed on-off valve 17 is opened, fuel (having the same pressure as that of fuel to be injected (atomized)) discharged under pressure from the discharge portion 11b of the pressure pump 11 is also fed to each of the plurality of counterforce source chambers 13-7. The shape and size of the counterforce source chambers 13-7 are the same as those of the chambers 13-2.

As in the case of the counterforce medium feed path 13-6, the counterforce medium release path 13-9 is a space defined by the side wall surface of a substantially U-shaped cutout formed in the stainless sheet 13j, the upper surface of the stainless sheet 13i, and the lower surface of the stainless sheet 13k. The substantially U-shaped cutout is formed in such a manner as to extend, along the X-Y plane, in the positive direction of the Y-axis and in the negative direction of the Y-axis from a portion communicating with the bottom end (an end located in the negative direction of the Z-axis) of the counterforce medium release port 13-12, which is a space defined by the side wall of a cylindrical through-hole extending in the direction of the Z-axis, and to then extend in the positive direction of the X-axis. The counterforce medium release path 13-9 is located above another portion of each of the counterforce source chambers 13-7, thereby communicating, at the position corresponding to the portion, with each of the counterforce source chambers 13-7 via the cylindrical counterforce medium release hole 13-10 formed in the stainless sheet 13i.

The counterforce medium release path 13-9 communicates with the liquid storage tank 22 via the counterforce medium release port 13-12 and the counterforce medium release pipe 18, in which the solenoid-operated counterforce medium release on-off valve 19 is installed. When the solenoid-operated counterforce medium release on-off valve 19 is opened, liquid in the counterforce source chambers 13-7 is returned to the liquid storage tank 22.

The piezoelectric/electrostrictive element accommodation chamber 13-13 is a single closed space defined by the side wall surface of a substantially rectangular cutout formed in the stainless sheet 13f and extending along the X-Y plane, the upper surface of the ceramic sheet 13e, and the lower surface of the stainless sheet 13g. The piezoelectric/electrostrictive element accommodation chamber 13-13 accommodates all of the 18 piezoelectric/electrostrictive elements 13B2, which are arranged in such a manner as to be nine per row, 18 in total.

The piezoelectric/electrostrictive elements 13B2 are slightly smaller than the corresponding chambers 13-2 and counterforce source chambers 13-7 as viewed in a planar manner (as viewed from the positive direction of the Z-axis). The fixation surface 13B2a (a plane extending along the X-Y plane and located toward the negative side along the Z-axis), or the lower surface, of each of the piezoelectric/electrostrictive elements 13B2 is fixed (joined through firing) to the upper surface of the ceramic sheet 13e in such a manner as to be disposed within the corresponding chamber 13-2 as viewed in a planar manner. The nonfixation surface 13B2b (a plane extending along the X-Y plane and located toward the positive side along the Z-axis), or the upper surface, of each of the piezoelectric/electrostrictive elements 13B2 is bonded to the lower surface of the stainless sheet 13g in such a manner as to be disposed within the corresponding counterforce source chamber 13-7 as viewed in a planar manner (as viewed from the positive direction of the Z-axis).

Hence, the fixation surface 13B2a of each of the piezoelectric/electrostrictive elements 13B2 receives, via the ceramic sheet 13e, a force induced by liquid pressure in the corresponding chamber 13-2 and directed in the positive direction of the Z-axis. The nonfixation surface 13B2b of each of the piezoelectric/electrostrictive elements 13B2 receives a force which is induced by liquid pressure in the corresponding counterforce source chamber 13-7, directed in the negative direction of the Z-axis, and imposed thereon as a counterforce via the stainless sheet 13g (indirectly). In other words, a force induced by liquid pressure in the counterforce source chamber 13-7 and directed in the negative direction of the Z-axis (a counterforce directed toward the fixation surface 13B2a) is imposed indirectly on the nonfixation surface 13B2b of the piezoelectric/electrostrictive element 13B2.

An unillustrated plus electrode and an unillustrated minus electrode are disposed in the vicinity of the upper surface and the lower surface, respectively, of each of the piezoelectric/electrostrictive elements 13B2. When a potential difference is cyclically applied between the electrodes according to the drive voltage signal DV issued from a drive voltage generation device (circuit) of the electrical control unit 30, the piezoelectric/electrostrictive element 13B2 is deformed in the following manner: while the potential difference is applied, the piezoelectric/electrostrictive element 13B2 contracts mainly in the direction of the X-axis (also contracts slightly in the direction of the Y-axis and in the direction of the Z-axis) from an original size; and while the potential difference is not applied, the piezoelectric/electrostrictive element 13B2 is restored to the original size (thus expands in the direction of the X-axis). Hence, the piezoelectric/electrostrictive element 13B2 cyclically deforms (vibrates) the ceramic sheet 13e (and the stainless sheet 13g) in the negative direction of the Z-axis. As a result, the volume of the corresponding chamber 13-2 is changed by ΔV.

Through employment of the above configuration, fuel which is discharged/fed to the liquid feed path 13-1 from the fuel injector 15 via the liquid inlet 13-5 is introduced into the chambers 13-2 via the corresponding liquid introduction holes 13-3. Vibration energy is applied to fuel in the chambers 13-2, whereby the fuel is injected in the form of fine (atomized) liquid droplets into the intake pipe 20 from the liquid injection ports 13-4a via the liquid discharge nozzles 13-4.

Also, at the same time, fuel which is fed to the counterforce medium feed path 13-6 from the solenoid-operated counterforce medium feed on-off valve 17 via the counterforce medium feed port 13-11 is introduced into the counterforce source chambers 13-7 via the corresponding counterforce medium introduction holes 13-8, whereby a force induced by liquid pressure in each of the counterforce source chambers 13-7 and directed in the negative direction of the Z-axis is imposed indirectly on the nonfixation surface 13B2b of each of the piezoelectric/electrostrictive elements 13B2 via the stainless sheet 13g.

Furthermore, when the solenoid-operated counterforce medium release on-off valve 19 is opened, fuel in the counterforce source chambers 13-7 returns to the liquid storage tank 22 via the counterforce medium release holes 13-10, the counterforce medium release path 13-9, the counterforce medium release port 13-12, and the counterforce medium release pipe 18, in which the solenoid-operated counterforce medium release on-off valve 19 is installed.

The injection unit 13 is fabricated in the following manner. First, the ceramic sheets 13a to 13e, and the flow path formation portion 13A, which is a laminate of the ceramic sheets 13a to 13e, are fabricated by the following method.

1: Ceramic green sheets are formed by use of zirconia powder having a particle size of 0.1 to several micrometers.

2: Punching is performed on this ceramic green sheet by use of punches and dies so as to form cutouts corresponding to those in the ceramic sheets 13a to 13e shown in FIG. 3 (cutouts corresponding to the liquid feed path 13-1, the chambers 13-2, the liquid introduction holes 13-3, the liquid discharge nozzles 13-4, and the liquid inlet 13-5 (see FIG. 4)).

3: The ceramic green sheets are arranged in layers. The resultant laminate is heated under pressure, followed by subjection to firing for 2 hours at 1,450° C. for integration.

The stainless sheets 13f to 13k, and the counterforce application mechanism portion 13B1, which is a laminate of the stainless sheets 13f to 13k, are fabricated by the following method.

1: A general-purpose stainless sheet is formed by use of stainless steel (SUS304).

2: Etching is performed on the general-purpose stainless sheet so as to form cutouts corresponding to those in the stainless sheets 13f to 13k shown in FIG. 3 (cutouts corresponding to the liquid inlet 13-5 (see FIG. 1), the counterforce medium feed path 13-6, the counterforce source chambers 13-7, the counterforce medium introduction holes 13-8, the counterforce medium release path 13-9, the counterforce medium release holes 13-10, the counterforce medium feed port 13-11 (see FIG. 1), and the counterforce medium release port 13-12 (see FIG. 1)), thereby forming the stainless sheets 13f to 13k.

3: The stainless sheets 13f to 13k are arranged in layers. The resultant laminate undergoes diffusion bonding for integration.

After the piezoelectric/electrostrictive elements 13B2 each being sandwiched between electrodes are formed on the ceramic sheet 13e of the above-formed flow path formation portion 13A at positions corresponding to the chambers, adhesive is applied to the entire lower surface of the stainless sheet 13f of the above-formed counterforce application mechanism portion 13B1 and to the nonfixation surfaces 13B2b (upper surfaces) of the piezoelectric/electrostrictive elements 13B2. The bottom surface of the counterforce application mechanism portion 13B1 (the lower surface of the stainless sheet 13f) is bonded to the top surface of the flow path formation portion 13A (the upper surface of the ceramic sheet 13e), and simultaneously the nonfixation surfaces 13B2b of the piezoelectric/electrostrictive elements 13B2 and the lower surface of the stainless sheet 13g are bonded together. Thus is fabricated the injection unit 13.

Referring back to FIG. 1, the regulator 14 is configured so as to function in the following manner: on the basis of pressure in the intake pipe 20 that is applied to the regulator 14 through unillustrated piping, the regulator 14 reduces (or regulates) the pressure of fuel pressurized by the pressure pump 11 such that the pressure of fuel in the liquid feed pipe 12 extending between the regulator 14 and the fuel injector 15 becomes a pressure (called “regulation pressure”) that is a predetermined pressure (a constant pressure) higher than the pressure in the intake pipe 20. As a result, when the fuel injector 15 is opened for a predetermined time, fuel is injected into the intake pipe 20 in an amount substantially proportional to the predetermined time, irrespective of pressure in the intake pipe 20.

The fuel injector 15 is a known injector which is conventionally of wide employment in an electrically controlled fuel injection apparatus. The fuel injector 15 herein functions as a solenoid-operated on-off valve (solenoid-operated on-off discharge valve) and includes an unillustrated liquid introduction port to which fuel that is regulated to the regulation pressure by means of the regulator 14 is introduced; an unillustrated liquid path; an unillustrated solenoid-operated on-off needle valve (solenoid valve) adapted to open and close the liquid path; and an unillustrated liquid discharge port. The fuel injector 15 is designed to discharge fuel regulated to the regulation pressure from the liquid discharge port only when the solenoid-operated on-off needle valve is opened in response to a high-level drive signal INJ issued from the electrical control unit 30.

The solenoid-operated counterforce medium feed on-off valve 17 is designed to feed fuel which is regulated to the regulation pressure by means of the regulator 14, toward the injection unit 13 (counterforce source chambers 13-7) only when the same is opened in response to a high-level drive signal SV issued from the electrical control unit 30. The solenoid-operated counterforce medium release on-off valve 19 is designed to return (release) fuel in the counterforce source chambers 13-7 to the liquid storage tank 22 only when the same is opened in response to a high-level drive signal RV issued from the electrical control unit 30.

As shown in FIG. 1, the electrical control unit 30 is connected to a water temperature sensor 31 for detecting the temperature of engine cooling water, an engine speed sensor 32 for detecting the rotational speed of engine, and an accelerator opening sensor 33 for detecting accelerator opening. Receiving engine speed N and accelerator opening Accp from these sensors, the electrical control unit 30 determines the amount of fuel required for an internal combustion engine.

The electrical control unit 30 is designed to send the drive signal INJ of high level (a valve opening signal) to the fuel injector 15 for a time corresponding to the determined amount of fuel and, as will be described later, to send the drive signal SV and the drive signal RV to the solenoid-operated counterforce medium feed on-off valve 17 and the solenoid-operated counterforce medium release on-off valve 19, respectively, at the timing of the drive signal INJ being of high level.

The electrical control unit 30 includes a drive voltage signal generation circuit for applying the drive voltage signal DV of frequency f (period T) between unillustrated electrodes of each of the piezoelectric/electrostrictive elements 13B2. In this case, the drive frequency f is equal to the resonance frequency (characteristic frequency) of the injection unit 13, the resonance frequency depending on the structure of the chamber 13-2, the structure of the liquid discharge nozzle 13-4, the nozzle diameter D, the introduction hole diameter d, the shape of a portion of the piezoelectric/electrostrictive element 13B2 which causes deformation of the ceramic sheet 13e (and the stainless sheet 13g), the kind of fuel, among others. For example, the drive frequency f is set to a frequency near 50 kHz.

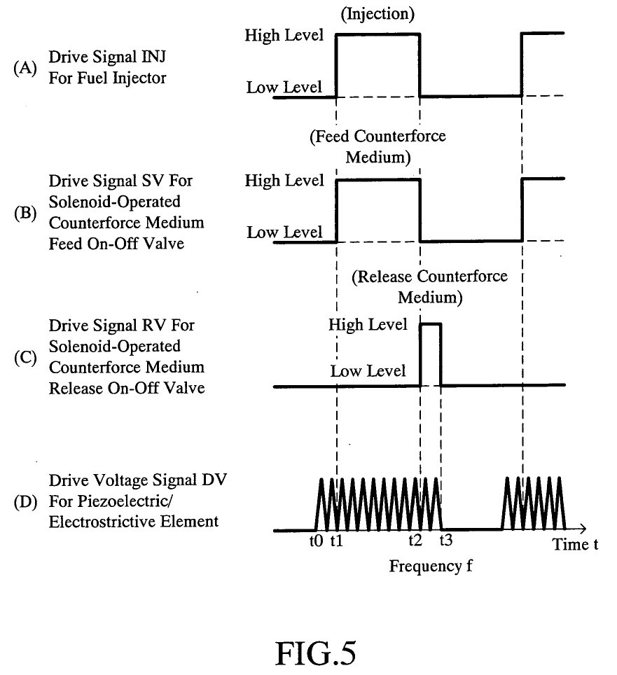

Time-course relationship among the drive signal INJ, the drive signal SV, the drive signal RV, and the drive voltage signal DV will be described with reference to FIG. 5. As shown in FIG. 5(D), the electrical control unit 30 begins to apply the drive voltage signal DV to the piezoelectric/electrostrictive elements 13B2 at the same time as time t1 when a leading edge of the drive signal INJ sent to the fuel injector 15 and shown in FIG. 5(A) arises (when the drive signal INJ changes from the low level to the high level), or at time t0 immediately before time t1. The electrical control unit 30 continues applying the drive voltage signal DV to the piezoelectric/electrostrictive elements 13B2 until time t3, which is a predetermined time behind time t2 when a trailing edge of the drive signal INJ sent to the fuel injector 15 arises (when the drive signal INJ changes from the high level to the low level) and which is a time when the pressure of liquid in the liquid feed path 13-1 drops to the steady-state pressure as exhibited when the fuel injector 15 is closed. At time t3, the electrical control unit 30 terminates application of the drive voltage signal DV.

As shown in FIG. 5(B), the electrical control unit 30 causes the drive signal SV to change from the low level to the high level at the same time as time t1 when a leading edge of the drive signal INJ shown in FIG. 5(A) arises; maintains the drive signal SV at the high level until the same time as time t2 when a trailing edge of the drive signal INJ arises; and causes, at time t2, the drive signal SV to change from the high level to the low level.

As shown in FIG. 5(C), the electrical control unit 30 causes the drive signal RV to change from the low level to the high level at the same time as time t2 when a trailing edge of the drive signal INJ shown in FIG. 5(A) arises; maintains the drive signal RV at the high level until the above-mentioned time t3; and causes, at time t3, the drive signal RV to change from the high level to the low level.

Next, the operation of the liquid injection apparatus configured as described above will be described. On the basis of engine operation conditions such as engine speed N and accelerator opening Accp, the electrical control unit 30 determines the drive signal INJ (the length of the high-level period) and the timing (time t1 in FIG. 5) of output of the drive signal INJ. At time t0, which is a predetermined time before time t1, the electrical control unit 30 begins to apply the drive voltage signal DV of the frequency f between electrodes of each of the piezoelectric/electrostrictive elements 13B2. At time t1, the electrical control unit 30 applies the drive signal INJ to the fuel injector 15.

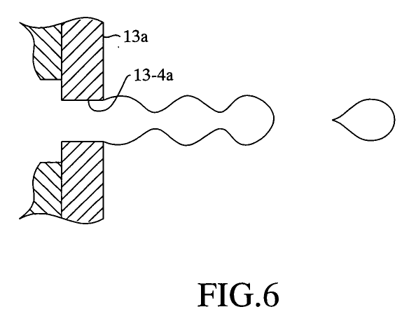

At time t1, the fuel injector 15 is opened, whereby liquid which is regulated to the regulation pressure by means of the regulator 14 begins to be discharged from the liquid discharge port of the fuel injector 15 and to be fed into the liquid feed path 13-1 of the injection unit 13 via the liquid inlet 13-5 of the injection unit 13. As a result, the pressure of fuel in the liquid feed path 13-1 begins to rise. When the pressure of fuel in the chambers 13-2 rises to a sufficient pressure (near the regulation pressure), as shown in FIG. 6, fuel is pressed out (injected) from the end face of each of the liquid injection ports 13-4a toward the liquid injection space 21 in the intake pipe 20. At this time, since vibration energy induced by the operation of the piezoelectric/electrostrictive elements 13B2 is applied to fuel contained in the corresponding chambers 13-2, constricted portions are formed on the fuel. Thus, a leading end portion of the fuel leaves the remaining portion of the fuel while being torn off at its constricted portion. As a result, uniformly and finely atomized fuel is injected into the intake pipe 20 at a predetermined injection speed.

At the same time, at time t1, the solenoid-operated counterforce medium feed on-off valve 17 is opened, whereby liquid which is regulated to the regulation pressure by means of the regulator 14 begins to be fed into the counterforce medium path 13-6 of the injection unit 13 from the solenoid-operated counterforce medium feed on-off valve 17 via the counterforce medium feed port 13-11 of the injection unit 13. At this time, since the solenoid-operated counterforce medium release on-off valve 19 is closed, the pressure of fuel in the counterforce medium feed path 13-6 begins to rise, and liquid pressure in the counterforce source chambers 13-7 is immediately increased to the regulation pressure which is attained through regulation by the regulator 14.

Thus, a force which is induced by liquid pressure in each of the counterforce source chambers 13-7, the liquid pressure having reached the regulation pressure, and which is directed in the negative direction of the Z-axis is imposed as a counterforce indirectly on the nonfixation surface 13B2b of each of the corresponding piezoelectric/electrostrictive elements 13B2 via the stainless sheet 13g. At this time, a force which is induced by liquid pressure in each of the chambers 13-2, the liquid pressure having reached a pressure near the regulation pressure, and which is directed in the positive direction of the Z-axis is imposed on the fixation surface 13B2a of each of the piezoelectric/electrostrictive elements 13B2 via the ceramic sheet 13e.

In other words, the magnitude of a component of a force induced by liquid pressure in the counterforce source chamber 13-7, the component being directed in the negative direction of the Z-axis (in a deformation direction of the wall (the ceramic sheet 13e) of the chamber 13-2), becomes substantially equal to the magnitude of a component of a force induced by liquid pressure in the chamber 13-2, the component being directed in the positive direction of the Z-axis (in a deformation direction of the wall of the chamber 13-2). Therefore, if the rigidity of the ceramic sheet 13e in terms of deformation of the ceramic sheet 13e in the direction of the Z-axis is equal to the rigidity of the stainless sheet 13g in terms of deformation of the stainless sheet 13g in the direction of the Z-axis, a component of the counterforce, the component being directed in the direction of the Z-axis (in the deformation direction of the wall of the chamber 13-2) and exerted on each of the piezoelectric/electrostrictive elements 13B2, and a component of a force induced by liquid pressure in each of the chambers 13-2, the component being directed in the direction of the Z-axis and exerted on each of the piezoelectric/electrostrictive elements 13B2, are almost completely canceled by each other, irrespective of the regulation pressure which is attained through regulation by the regulator 14.

At time t2, the fuel injector 15 is closed, whereby the pressure of liquid in the liquid feed path 13-1 (and in the chambers 13-2) begins to decrease, and thus the fuel injection speed begins to decrease. Also, the solenoid-operated counterforce medium feed on-off valve 17 is closed, and the solenoid-operated counterforce medium release on-off valve 19 is opened, whereby feed of fuel of the regulation pressure to the counterforce source chambers 13-7 is terminated, and release of fuel in the counterforce source chambers 13-7 to the liquid storage tank 22 is started. Thus, the liquid pressure of fuel in the counterforce source chambers 13-7 immediately decreases to the atmospheric pressure.

At time t3, the pressure of liquid in the liquid feed path 13-1 (and in the chambers 13-2) drops to the steady-state pressure as exhibited when the fuel injector 15 is closed, and injection of fuel is completely terminated.

In the above-described embodiment, the intensity of vibration to be applied to fuel varies depending on the potential difference applied between unillustrated electrodes provided on the upper and lower surfaces of each of the piezoelectric/electrostrictive elements 13B2 (i.e., the maximum voltage of the drive voltage signal DV and the intensity of electric field applied to the piezoelectric/electrostrictive elements 13B2), the thickness of the ceramic sheet 13e (the wall of the chambers 13-2), the thickness of the stainless sheet 13g, among others. In the present embodiment, the ceramic sheet 13e (and the stainless sheet 13g) is deformed in the direction of the Z-axis through operation of the piezoelectric/electrostrictive elements 13B2, and the volume change quantity ΔV of each of the chambers 13-2 stemming from the deformation is determined such that the ratio of the volume V of the chamber 13-2 to the volume change quantity ΔV; i.e., V/ΔV (chamber volume/volume change quantity), is 1,500. Notably, the ratio V/ΔV is preferably not less than 2 and not greater than 3,000, particularly not less than 2 and not greater than 1,500.

Gasoline injected under the above conditions exhibits a uniform liquid droplet diameter of 30 μm; as a result, fuel economy can be enhanced, and harmful exhaust gas can be reduced.

As described above, the liquid injection apparatus according to the embodiment of the present invention can stably inject uniformly atomized liquid (gasoline), irrespective of the condition of engine operation (i.e., environmental conditions of the liquid injection apparatus). In a conventional carburetor, the flow rate of fuel is determined according to air velocity within an intake pipe, which is a liquid droplet discharge space, and the degree of atomization varies depending on the air velocity. By contrast, according to the above-described embodiment, fuel can be ejected by a required amount in a well-atomized condition irrespective of air velocity. Furthermore, in contrast to a conventional apparatus in which assist air is fed to a nozzle portion of a fuel injector so as to accelerate fuel atomization, the liquid injection apparatus of the present invention does not require a compressor for feeding assist air, thereby lowering apparatus cost.

Fuel is pressurized by means of the pressure pump 11, whereby fuel under pressure is injected into the liquid injection space 21 in the intake pipe 20; therefore, even when pressure in the liquid injection space 21 (intake pressure) fluctuates, a required amount of fuel can be stably injected.

Vibration energy is applied to fuel through variation of the volume of the chambers 13-2 of the injection unit 13, whereby the fuel is atomized and then injected from the liquid discharge nozzles 13-4a. As a result, the present liquid fuel injection apparatus can inject liquid droplets which are atomized to a highly fine degree. Furthermore, since the injection unit 13 includes a plurality of chambers 13-2 and a plurality of discharge nozzles 13-4, even when bubbles are generated within fuel, the bubbles tend to be finely divided, thereby avoiding great fluctuations in the amount of injection which would otherwise result from the presence of bubbles.

The magnitude of a component of a force induced by liquid pressure in the counterforce source chamber 13-7, the component being directed in the negative direction of the Z-axis (in a deformation direction of the wall (the ceramic sheet 13e) of the chamber 13-2), becomes substantially equal to the magnitude of a component of a force induced by liquid pressure in the chamber 13-2, the component being directed in the positive direction of the Z-axis (in a deformation direction of the wall of the chamber 13-2). Therefore, if the rigidity of the ceramic sheet 13e in terms of deformation of the ceramic sheet 13e in the direction of the Z-axis is equal to the rigidity of the stainless sheet 13g in terms of deformation of the stainless sheet 13g in the direction of the Z-axis, a component of the counterforce, the component being directed in the direction of the Z-axis (in the deformation direction of the wall of the chamber 13-2) and exerted on each of the piezoelectric/electrostrictive elements 13B2, and a component of a force induced by liquid pressure in each of the chambers 13-2, the component being directed in the direction of the Z-axis and exerted on each of the piezoelectric/electrostrictive elements 13B2, are almost completely canceled by each other, irrespective of the regulation pressure which is attained through regulation by the regulator 14.

Therefore, preferably, the present apparatus is configured such that the rigidity of the ceramic sheet 13e in terms of deformation of the ceramic sheet 13e in the direction of the Z-axis (the degree of deformation upon exposure to liquid pressure in the chamber 13-2) is equal to the rigidity of the stainless sheet 13g in terms of deformation of the stainless sheet 13g in the direction of the Z-axis (the degree of deformation upon exposure to liquid pressure in the counterforce source chamber 13-7).

As a result, the magnitude of a force required to expand and contract (to perform contraction of) the piezoelectric/electrostrictive element 13B2 when the wall of the chamber 13-2 is to be deformed by a predetermined amount (when the volume of the chamber 13-2 is to be deformed by ΔV) can be stably reduced, irrespective of liquid pressure in the chamber 13-2, to the magnitude of a force required when liquid pressure in the chamber 13-2 is very low. Therefore, even when the liquid injection apparatus 10 is used in an environment which requires injection of liquid under considerably high pressure, the liquid can be injected stably, and power consumption of the liquid injection apparatus 10 can be reduced.

In the above-described liquid injection apparatus, the start of generation of the drive voltage signal DV leads the start of generation of the drive signal INJ, and the disappearance of the drive voltage signal DV lags the disappearance of the drive signal INJ. As a result, vibration energy is applied to fuel to be injected, at all times. Thus, even at the time of starting and ending injection, fuel can be reliably injected in an atomized condition. Since the drive voltage signal DV is generated only when required, power consumption can be reduced.

The present invention is not limited to the above-described embodiment, but may be embodied in various other forms within the scope of the present invention. For example, the liquid injection apparatus of the above-described embodiment is applied to an internal combustion engine, but may be applicable to other machinery which utilizes atomized droplets of liquid raw material.

The flow path formation portion 13A, which partially constitutes the injection unit 13 of the liquid injection apparatus of the above-described embodiment, is composed of a plurality of zirconia ceramic thin-plate members 13a to 13e. However, for example, as in the case of the counterforce application mechanism portion 13B1, the flow path formation portion 13A may be composed of a plurality of stainless steel thin-plate members. This enhances the toughness of a wall of each of the chambers 13-2, the wall functioning as a diaphragm which deforms and vibrates through operation of each of the piezoelectric/electrostrictive elements 13B2; as a result, the durability of the wall is enhanced.

Also, in the liquid injection apparatus of the above-described embodiment, the nonfixation surfaces 13B2b (upper surfaces) of the piezoelectric/electrostrictive elements 13B2 and the lower surface of the stainless sheet 13g are bonded together. However, the nonfixation surfaces 13B2b and the lower surface of the stainless sheet 13g may not be bonded together. In this case, preferably, the piezoelectric/electrostrictive element accommodation chamber 13-13 is filled with incompressible fluid (fluid which can be handled as having constant density during flow). The reason for this is described below.

When, in such a state that the nonfixation surfaces 13B2b and the lower surface of the stainless sheet 13g are not bonded together, the present apparatus is operated to thereby inject fuel, the nonfixation surfaces 13B2b and the lower surface of the stainless sheet 13g may come in a point contact with each other, since the radius of curvature of the nonfixation surfaces 13B2 and the radius of curvature of the lower surface of the stainless sheet 13g differ from each other. At this time, if the piezoelectric/electrostrictive element accommodation chamber 13-13 is not filled with incompressible fluid, a force induced by liquid pressure in the counterforce source chambers 13-7 is transmitted to the nonfixation surfaces 13B2b only via points of contact between the nonfixation surfaces 13B2b and the lower surface of the stainless sheet 13g. As a result, a force induced by liquid pressure in the counterforce source chambers 13-7 is not properly transmitted to the nonfixation surfaces 13B2b, and thus the above-mentioned counterforce may decrease.

By contrast, if the piezoelectric/electrostrictive accommodation chamber 13-13 is filled with incompressible fluid, liquid pressure close to that in the counterforce source chambers 13-7 arises in the incompressible fluid. This liquid pressure (hydrostatic pressure) of the incompressible fluid is uniformly exerted on the entire region of each of the nonfixation surfaces 13B2b; thus, a force induced by liquid pressure in the counterforce source chambers 13-7 is properly transmitted to the nonfixation surfaces 13B2b. Therefore, it is expected that a counterforce can be obtained which is equivalent to that obtained in the above-described embodiment, in which the nonfixation surfaces 13B2b (upper surfaces) and the lower surface of the stainless sheet 13g are bonded together.

In the liquid injection apparatus of the above-described embodiment, the stainless sheet 13g may be eliminated. Also in this case, as in the above-described case where incompressible fluid is employed as a filler, liquid pressure in the counterforce source chambers 13-7 is uniformly exerted on the entire region of each of the nonfixation surfaces 13B2b. Therefore, it is expected that a counterforce can be obtained which is equivalent to that obtained in the above-described embodiment, in which the nonfixation surfaces 13B2b (upper surfaces) and the lower surface of the stainless sheet 13g are bonded together.

In the liquid injection apparatus of the above-described embodiment, a force induced by liquid pressure in the counterforce source chambers 13-7 is applied, as a counterforce, to the nonfixation surfaces 13B2b of the piezoelectric/electrostrictive elements 13B2. However, an electrical counterforce generation unit (e.g., a unit including an electric motor and the like) dedicated to application of the counterforce, or a like device may be employed so as to apply a counterforce to the nonfixation surfaces 13B2b.

The liquid injection apparatus of the above-described embodiment is applied to a gasoline-fueled internal combustion engine in which fuel is injected into the intake pipe 20. However, the liquid injection apparatus of the present invention is effectively applied to a so-called “direct-injection-type gasoline-fueled internal combustion engine,” in which fuel is injected directly into cylinders. Specifically, when fuel is injected directly into a cylinder by means of an electrically controlled fuel injection apparatus which uses a conventional fuel injector, fuel may be caught in a gap (crevice) between a cylinder and a piston, potentially resulting in an increase in the amount of unburnt HC (hydrocarbon). By contrast, when fuel is injected directly into a cylinder by use of the liquid injection apparatus according to the present invention, fuel is injected in an atomized condition into the cylinder, whereby the amount of fuel adhesion to the inner wall surface of the cylinder can be reduced, or the amount of fuel entering the gap between a cylinder and a piston can be reduced, thereby reducing exhaust of unburnt HC.

In the “direct-injection-type gasoline-fueled internal combustion engine,” fuel must be injected directly into a cylinder filled with compressed air of high pressure. Thus, when a liquid injection apparatus is to be applied to the “direct-injection-type gasoline-fueled internal combustion engine,” liquid must be injected at a pressure higher than the high pressure of the compressed air. As described above, the liquid injection apparatus according to the present invention can inject liquid at a pressure higher than the high pressure of the compressed air and, in this case, allows reduction in required power consumption.

Furthermore, the liquid injection apparatus according to the present invention is effectively used as an injector for use in a diesel engine. Specifically, a conventional injector involves a problem of failure to inject atomized fuel, particularly in low-load operation of the engine, in which fuel pressure is low. In this case, if a common-rail-type injection apparatus is used, fuel pressure can be increased to a certain extent even when the engine is rotating at low speed, and thus atomization of injected fuel can be accelerated. However, since fuel pressure is lower as compared with the case where the engine is rotating at high speed, fuel cannot be sufficiently atomized. By contrast, since the liquid injection apparatus according to the present invention is configured such that fuel is atomized through operation of the piezoelectric/electrostrictive elements 13B2, sufficiently atomized fuel can be injected irrespective of engine load (i.e., even when the engine is running at low load).

What is claimed is:

1. A liquid injection apparatus comprising:
an injection unit comprising a flow path formation portion, the flow path formation portion including a liquid discharge nozzle, one end of the liquid discharge nozzle being exposed to a liquid injection space, and a chamber communicating with the other end of the liquid discharge nozzle and with one end of a liquid feed pipe;
a drive voltage generation device for generating a drive voltage signal having a predetermined frequency; and
a pressurizing device comprising a discharge portion connected to the other end of the liquid feed pipe and an introduction portion communicating with a liquid storage tank, the pressurizing device being adapted to pressurize liquid introduced from the liquid storage tank through the introduction portion and to discharge the liquid under pressure from the discharge portion, so as to inject the liquid into the liquid injection space via the chamber and the liquid discharge nozzle of the injection unit;
wherein the injection unit further comprises a pressurizing portion, the pressurizing portion including a piezoelectric/electrostrictive element which has a fixation surface fixed to an outer surface of a wall of the chamber and receiving, via the wall, a force induced by liquid pressure in the chamber and which expands and contracts mainly in a direction along the fixation surface so as to deform the wall of the chamber for changing a volume of the chamber, and a counterforce application mechanism which applies to a nonfixation surface of the piezoelectric/electrostrictive element a counterforce directed toward the fixation surface; and
the injection unit is configured to cause the piezoelectric/electrostrictive element to expand and contract based on the drive voltage signal issued from the drive voltage generation device, so as to atomize liquid injected from the liquid discharge nozzle.

2. A liquid injection apparatus according to claim 1, wherein the counterforce application mechanism is configured in such a manner as to adjust a magnitude of the counterforce such that a magnitude of a component of the counterforce, the component being directed in a deformation direction of the wall of the chamber, becomes substantially equal to a magnitude of a component of the force induced by liquid pressure in the chamber, the component being directed in the deformation direction of the wall of the chamber and imposed on the fixation surface.

3. A liquid injection apparatus according to claim 1, wherein the counterforce application mechanism comprises a counterforce source chamber into which liquid discharged from the discharge portion of the pressurizing device is introduced, and is configured such that a force induced by liquid pressure in the counterforce source chamber is applied, as the counterforce, to the nonfixation surface of the piezoelectric/electrostrictive element.

4. A liquid injection apparatus according to claim 2, wherein the counterforce application mechanism comprises a counterforce source chamber into which liquid discharged from the discharge portion of the pressurizing device is introduced, and is configured such that a force induced by liquid pressure in the counterforce source chamber is applied, as the counterforce, to the nonfixation surface of the piezoelectric/electrostrictive element.
